(19) United States
(12) Patent Application Publication
(10) Pub. No.: US 2018/0142779 A1
(43) Pub. Date: May 24, 2018

(54) ACTUATING DEVICE FOR AN ELECTRO-MECHANICAL OR HYDRO-MECHANICAL MOTOR VEHICLE TRANSMISSION SYSTEM, ESPECIALLY OF AN AGRICULTURAL COMMERCIAL VEHICLE

(71) Applicant: PREH GMBH, Bad Neustadt a. d. Saale (DE)

(72) Inventors: Maximilian TÜRPITZ, Bad Neustadt a. d. Saale (DE); Andreas KAIL, Bad Neustadt (DE)

(73) Assignee: PREH GMBH, Bad Neustadt a. d. Saale (DE)

(21) Appl. No.: 15/819,789

(22) Filed: Nov. 21, 2017

(30) Foreign Application Priority Data
Nov. 21, 2016 (DE) 10 2016 122 344.1

(51) Int. Cl. F16H 59/04; F16H 61/24; F16H 59/02; F16H 59/10; G01D 5/20

(52) U.S. Cl. CPC F16H 59/044; F16H 61/24; F16H 59/0204; F16H 2061/242; G01D 5/20; F16H 2059/0265; F16H 2059/0295; F16H 59/105

(57) ABSTRACT

The present disclosure relates to an actuating device for an electro-mechanical motor vehicle transmission system, comprising a housing, a shift lever, a flat mechanical linkage, wherein the shift lever is movably supported at housing for shifting between gear ratios, wherein the shift lever is movably supported in each one of the shift gate in a shifting direction by means of the flat mechanical linkage and is pivotably supported in at least one selection gate about a selection axis for selecting among different shift gates, as well as a detection device, which is designed to detect a displacement of the shift lever in the shifting direction and pivoting of the shift lever about the selection axis.

This application claims priority to the German Application No. 10 2016 122 344.1, filed Nov. 21, 2016, now pending, the contents of which are hereby incorporated by reference.

The present disclosure relates to an actuating device for an electro-mechanical or hydro-mechanical motor vehicle transmission, especially of an agricultural commercial vehicle.

Such actuating devices, which are frequently used in connection with so called “shift-by-wire” transmission systems, also automatic transmission systems, commonly comprise a shift lever displaceable into different switching positions, by means of displacement thereof into a respective switching position the transmission may be actuated depending on the respective switching position. The actual switching operation is done in an electro-mechanical, especially electro-hydraulical or electromotive, or hydro-mechanical manner, while the respective intention to shift of the driver is electrically or electronically detected by means of displacement of the shift lever. In such transmission systems, the electrical switching device having the displaceable shift lever and eventually additional rocker switches that for example are arranged at the stirring wheel for up and downshifting is available to the driver.

For example, such shift levers, broadly also referred to as selection levers, gear levers, gear selection levers or gear selection switches, etc., may be displaced within two adjacently arranged shift gates. One of the shift gates may be a so called automatic gate, in which the shift lever may be put into or displaced, respectively, into multiple switching positions, such as for example P (“parking”—parking position with mechanical lock of the transmission against rolling away), R (“reverse” (reverse gear)), N (“neutral” (idle)), D (“drive” (forward travel with automatic gear selection), etc. The other one of the shift gates is provided in the automatic transmission system for manual gear selection, for example for engaging into a next higher or next lower gear of the automatic transmission system. However, there may also exist transmission system systems, wherein the end positions of each shift gate are associated to dedicated gears, i.e. reductions of the transmission system.

Normally, such shift levers are supported via a ball and socket bearing or a cardan bearing in relation to a housing. Such bearings require comparatively much installation space, and especially in such vehicles having functionally overloaded driver-machine-interfaces, such as agricultural commercial vehicles, they are hardly to be accommodated in the driver's cabin, especially if the shift lever is to be integrated into an armrest of a driver's seat.

In view of this background, there is a need of an actuating device for an electro-mechanical motor vehicle transmission system having comparatively reduced installation volume, wherein especially reliable operation is assured. This problem will be solved by an actuating device for an electro-mechanical motor vehicle transmission system according to claim 1. An equally advantageous use is the subject matter of the independent Use claim. Advantageous embodiments are the respective subject matter of the dependent Claims. It is to be noted that the characteristics individually set forth in the Claims may be combined among each other in any technologically reasonable manner, representing further embodiments of the present disclosure. The description, especially in connection with the figures, additionally characterizes and specifies the present disclosure.

The present disclosure relates to an actuating device for an electro-mechanical motor vehicle transmission system. According to the present disclosure, the actuating device comprises a housing. According to the present disclosure, the term housing is to be broadly interpreted, and does not necessarily mean another embodiment of the housing enveloping or accommodating any other component. For example, the housing is a mounting frame for attaching to a vehicle side component, for example a center console or an arm rest of a driver's seat.

According to the present disclosure, the actuating device furthermore comprises a shift lever, which is movably mounted to the housing for shifting between gear ratios. For example, it is a stick-like entity having a bulge at the free end, which is also referred to as a gear knob. According to the present disclosure, the shift lever is movably supported in each one of a shift gate in a shifting direction by means of a flat coupling gear and, for selecting among different shift gates, is pivotably supported about a selection axis in at least one selection gate. The selection gate and the shift gate or several ones thereof, respectively, are for example specified by a gear-shifting gate. According to the present disclosure, the actuating device furthermore comprises a detection device, which is designed for the detection of a displacement of the shift lever in the shifting direction and a pivoting movement of the shift lever about the selection axis. Preferably, the detection device is designed to perform each one of a contactless detection.

As a flat mechanical linkage, a transmission system with rotary axes parallel to each other of the pivot joints connecting the coupled elements is understood. By using a mechanical linkage not only a comparatively installation space-saving realization of a generic actuating device is achieved, but also possibility of being able to detect those displacements by different detection means of the detection device in a reliable and mechanically decoupled manner due to the differing mechanical configuration of the actuating directions, that is, on the one hand, along the selection gate and on the other hand along the shift gate.

Preferably, the mechanical linkage comprises a four-bar linkage formed as a double rocker, which comprises a first rocker pivotably supported in relation to the housing, and a second rocker pivotably supported in relation to the housing, wherein the rockers are hinge-connected via a linkage, wherein, according to the present disclosure, the shift lever is firmly attached to the linkage.

In one embodiment, the double rocker is formed as a parallelepiped. However, it is preferably provided that the distance of the housing-side joints of the first rocker and the second rocker is lower than the joint distance of the linkage. The shift lever thereby undergoes change of orientation during displacement along the shift gate that corresponds to a pivoting movement that corresponds to the shifting haptic of a conventional shift lever and thus will be perceived by the user as being comfortable. In one preferred embodiment, the first and second rocker have the same lengths, wherein as a length the effective length between the hinge axes thereof is understood.

According to another preferred embodiment, the first rocker and the second rocker are furthermore pivotably supported about the selection axis at the housing, for example in a direction orthogonal to the above-mentioned pivotability, to provide for the pivotability of the shift lever along the selection gate.

Preferably, the actuating device comprises a first position encoder cooperating with the detection device and being supported in a reciprocally movable manner for the detection of the displacement of the shift lever in the shifting direction, wherein the mechanical linkage furthermore comprises a slider that couples the first rocker or the second rocker or the linkage with the position encoder. In other words, the slider either is hinged immediately at the first rocker or immediately at the second rocker or immediately at the linkage, to convert the respective displacement thereof into a reciprocal displacement of the position encoder.

Preferably, the slider is hinged at one of the rockers among the first and second rocker. As the position encoder, an element cooperating with the detection device is understood, so that on the detection device side distinct displacement and/or position information is provided. Preferably, the first position encoder is being supported on the selection axis in a reciprocally displaceable manner in that the selection axis engages into a bore formed in the position encoder. For maintaining smooth-running displaceability, for example, a point or line contact between the outer selection axis circumference and the bore wall is formed in that the bore, for example, is excessively large in size, and a protruding groove is formed in the outer circumference of the selection axis or the bore wall.

According to another preferred embodiment, the actuating device comprises a second position encoder cooperating with the detection device and pivotably supported about the selection axis, the second position encoder being non-rotatably connected with the first rocker and second rocker.

The first position encoder and the second position encoder are preferably designed to cooperate with the detection device in a contactless manner, for example an optical, capacitive or magnetic manner. However, it is in agricultural usage, where inductive interaction between position encoders and detection device has been proven to be of advantage. For example, deposition of a cow magnet in the driver's cabin has been proven to be a source of disturbance to magnetic position detection, so that a detection device that inductively interacts with the first position encoder and the second position encoder has been proven to be especially preferred. For example, the detection device comprises one or more coils, the inductivity of which varies depending on the position of the position encoder or position encoders.

According to one preferred embodiment, resetting means for resetting the shift lever into a neutral position are furthermore provided. For example, a helical spring surrounding the selection axis is provided enforcing the reset position of the shift lever along the selection gate into a monostable neutral position.

The present disclosure furthermore relates to the use of the actuating device for an electro-mechanical motor vehicle transmission system in one of its previously described embodiments in a motor vehicle, especially in an agricultural commercial vehicle. Preferably, the actuating device is arranged in an armrest of the driver's seat of a driver's cabin of the agricultural commercial vehicle.

The present disclosure will be explained in more detail by way of the following figures. The figures are only to be understood as an example, merely representing preferred embodiment, wherein:

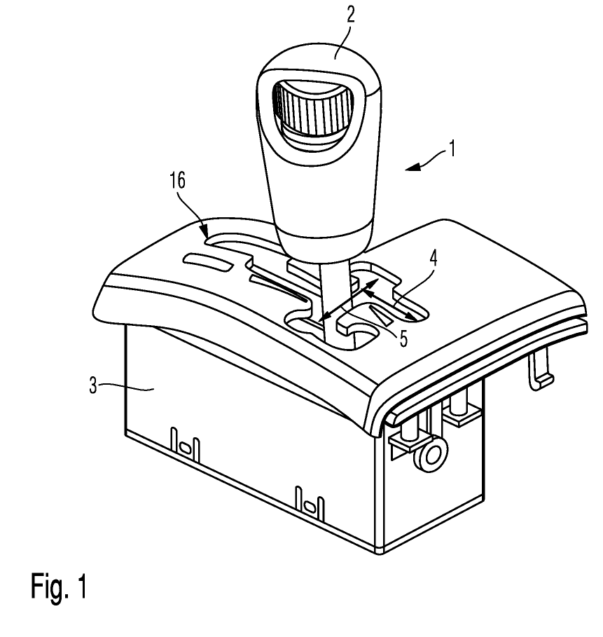

FIG. 1 is a perspective view of the actuating device according to the present disclosure;

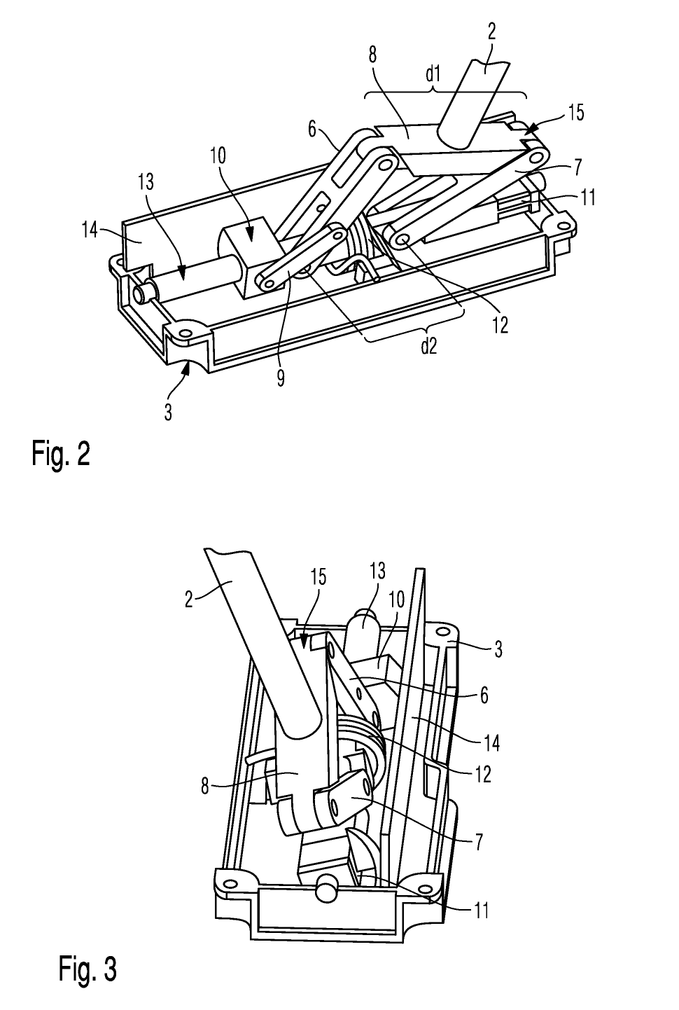

FIG. 2 is a detailed perspective representation of the actuating device shown in FIG. 1;

FIG. 3 is another detailed perspective representation of the actuating device according to the present disclosure of FIG. 1.

FIG. 1 shows an embodiment of the actuating device 1 according to the present disclosure. It comprises a shift lever 2 having a terminal gear knob. The shift lever 2 is movably attached to a housing 3, which in turn is accommodated in the armrest of a driver's seat of an agricultural commercial vehicle that is not shown. The shift lever 2 is guided in a motion link 16, comprising multiple shift gates 4 and multiple selection gates 5 orthogonally extending toward the shift gates 4 and connecting the shift gates 4, wherein the selection gates 5 are provided to be able to transfer the shift lever 2 from one shift gate 4 into another one. Especially the respective end positions of the shift lever 2 define respective gears or reduction ratios of a transmission system not shown, which is associated to the actuating device 1.

As it is shown in FIG. 2, only a flat mechanical linkage 15 provides for displaceability of the shift lever 2 along the shift gates 4. This flat mechanical linkage 15 comprises a double rocker, the double rocker being defined by the first rocker 6, the second rocker 7 and a linkage 8, which is hinge-connected to the first rocker 6 and the second rocker 7. The shift lever 2 is firmly connected to the linkage 8. The first rocker 6 and the second rocker are pivotably supported in relation to the housing 3, wherein they are rotatably supported not immediately at housing 3, but at a selection axis 13, which in turn is rotatably supported immediately at the housing 3. The axis of the selection axis 13 is orthogonal to the rotary axes of the first rocker 6 and the second rocker 7. Due to pivotability about selection axis 13, pivoting of the shift lever 2 along the selection gate 5 of FIG. 1 is allowed.

A helical spring 12 provides for resetting of the shift lever 2 into a monostable neutral position along the selection gate 5. The distance d1 of the rotary axes of the linkage 8 is larger than the distance d2 of the housing-side rotary axes of the rockers 6, 7, the shift lever 2 thereby not maintaining its orientation, but is described by pivoting occurring in the plane of the mechanical linkage 15 about an imaginary axis. The pivot joints between the linkage 8 and the associated rocker 6 and 7, respectively, may have a stopper to limit pivoting along the shift gate of the shift lever 2.

A slider 9 is hinged to the first rocker 6, which in turn is connected to a first position encoder 10, which in turn is displaceably supported along the selection axis 13. The position encoder 10 inductively cooperates with a detection device 14 arranged on a circuit board. It comprises for example multiple coils, the inductivity of which varies depending on the position of the first position encoder 10. As the position of the first rocker 6, and thus the position of the shift lever 2, specifies the position of the position encoder 10 along the selection axis 13, the detection device 14 is able to detect the position of the shift lever 2 along the shift gate 4 of FIG. 1.

For the detection of the pivoting position of the shift lever 2 along the selection gate 5 a second position encoder 11 is provided, which is non-rotatably connected to the second rocker 7 via the selection axis 13. This second position encoder 11 also inductively cooperates with the detection device 14, so that it is able to detect the position of the shift lever 2 along one of selection gates 5.

The respective surface facing the detection device 14 of the first position encoder 10 and of the second position encoder 11 is bulged according to the pivoting along the selection gate to essentially maintain a clearance to the detection device that is constant during pivoting.

1. An actuating device for a motor vehicle transmission system, comprising:
a housing, a shift lever, and a flat mechanical linkage, wherein the shift lever is movably mounted to the housing for shifting between gear ratios, and wherein the shift lever is movably supported in each one of a shift gate in a shifting direction by a flat mechanical linkage and is pivotably supported for selecting among different shift gates in at least one selection gate about a selection axis;
a detection device, which is designed to detect displacement of the shift lever in the shifting direction and pivoting of the shift lever about the selection axis.

2. The actuating device of claim 1, wherein the mechanical linkage comprises a four-bar linkage formed as a double rocker, which comprises a first rocker pivotably supported in relation to the housing and a second rocker pivotably supported in relation to the housing, wherein the first rocker and the second rocker are hinge-connected via a linkage and the shift lever is firmly attached to the linkage.

3. The actuating device of claim 2, wherein the distance between the housing-side rotary axes of the first rocker and the second rocker is lower than the joint distance of the linkage.

4. The actuating device of claim 2, wherein the first rocker and the second rocker are furthermore pivotably supported about the selection axis at the housing.

5. The actuating device of claim 2, wherein the actuating device comprises a first position encoder cooperating with the detection device and supported in a reciprocally displaceable manner, configured to detect the displacement of the shift lever in the shifting direction, and wherein the mechanical linkage comprises a slider, which couples the first rocker or the second rocker or the linkage to the position encoder.

6. The actuating device of claim 2, wherein the actuating device comprises a second position encoder cooperating with the detection device and pivotably supported about the selection axis, which second position encoder is non-rotatably connected to the first rocker and the second rocker.

7. The actuating device of claim 1, wherein the detection device inductively interacts with the first position encoder and/or the second position encoder.

8. The actuating device of claim 5, wherein the first position encoder is supported on the selection axis in a reciprocally displaceable manner.

9. The actuating device of claim 1, wherein furthermore resetting means are provided for resetting the shift lever into a neutral position.

10. The actuating device of claim 1 configured for use in a motor vehicle.

11. The actuating device of claim 10, wherein the motor vehicle is an agricultural commercial vehicle.
